(19) United States
(12) Patent Application Publication
(10) Pub. No.: US 2008/0308477 A1
(43) Pub. Date: Dec. 18, 2008

(54) CASCADING STORM DRAIN FILTER

(76) Inventor: John Hurst, Encinitas, CA (US)

Correspondence Address: LAW OFFICE OF DONALD L. WENSKAY, 16909 VIA DE SANTA FE, 200, P.O. BOX 7206, RANCHO SANTA FE, CA, 92057, US

(21) Appl. No.: 12/060,243

(22) Filed: Mar. 31, 2008

Related U.S. Application Data
(63) Continuation-in-part of application No. 11/343,150, filed on Jan. 30, 2006, now Pat. No. 7,438,802.
Application No. 11/343,150 is a continuation-in-part of application No. 10/980,941, filed on Nov. 3, 2004, now Pat. No. 7,208,082.
Application No. 10/980,941 is a continuation of application No. 11/591,921, filed on Nov. 2, 2006.

(51) Int. Cl. C02F 1/00; B01D 29/05; E03F 5/14

(52) U.S. Cl. 210/164; 210/339; 210/163

(57) ABSTRACT

In one aspect of the present invention, a fluid filter comprises a primary filter configured to filter water passing therethrough, the primary filter having first and second ends. A mount holds the planar filter in a chamber adjacent to an opening in the chamber, such that fluid passing through the opening substantially passes through the primary filter. The mount also holds the primary filter at an angle with respect to the opening such that the first end is closer to the planar surface than the second end and such that the second end, but not the first end, is in contact with a wall of the chamber. A downstream filter may also be used to provide a cascading effect permitting water to flow over the edge of the primary filter onto the downstream filter.

### REFERENCE TO RELATED APPLICATIONS

This application is a continuation-in-part of U.S. patent application Ser. No. 11/343,150, which is a continuation-part of U.S. patent application Ser. No. 10/980,941, filed Nov. 3, 2004 entitled Drainage Water Filter for Erosion Control, which is incorporated by reference herein in its entirety. This application is also related to U.S. patent application Ser. Nos. 11/591,921 and 12/052,716, which are both incorporated by reference herein in their entirety.

### BACKGROUND OF THE INVENTION

The present invention generally relates to storm drains and, more specifically, to below-grade storm drain filters.

At construction sites, dams such as rock bags (semi-porous bags filled with rocks) are typically used to filter the flow of water into storm drains, in order to protect the water quality of the bodies of water into which the storm drain flows, and also to prevent unwanted buildup of these contaminants within the drainage system, which could otherwise clog the drainage system.

For example, a number of rock bags may be positioned around a storm drain in order to filter drainage water from the construction site, and to prevent other construction contaminants from entering the storm drain, thereby reducing water pollution and protecting water quality.

In addition to the rock bags, other portable dams and erosion control systems have been developed. For example, straw waddles include a long tubular-shaped sheath of straw that slows and filters drainage water. Commercial products such as the Gutterbuddy™, available from ACF Environmental of Richmond, Va. (www.acfenvironmental.com) include synthetic fibers bundled in a tube. In addition, inlet protection systems such as the FiltR Fence™, also available from ACF Environmental, include a frame that has a screen-like geotextile sleeve that is attached around the frame's perimeter. In that design, the frame can be assembled by securing the frame members to each other with steel pins. The assembled frame is then placed to protect an inlet. The FiltR Fence™. frame can also be taken apart for ease of transportation.

These erosion control systems all have drawbacks. For example, rock bags are heavy, expensive to implement, and/or in practice do not function well to prevent pollution. For example, dirt quickly builds up within the rock bags and the other dams, rendering them effectively useless. Dirt and rocks also build up in front of the bags, eventually blocking the flow of water, all of which can create large puddles of backed-up water. While the proper practice would then be to shovel out the dirt and the backed-up water and replace the non-functional bags, in practice construction workers find it easier to just pick up one or two bags and let the water flow through the open space. Furthermore, in a big rainstorm, the flow of water may be so large and forceful as to simply flow right over the bags.

Optimally, the dirt and rocks that build up in front of the bags should be cleaned regularly in order to ensure proper function. However, the rock bags create a difficult obstacle for street sweeping, and rather than moving the heavy bags and re-positioning them, the street sweeper usually just drives around the bags, leaving the dirt and rock buildup in front of the bags.

In addition, the bags are often damaged when they are run over by heavy equipment at a construction site, and even if they are not damaged, eventually they deteriorate due to effects of weather (e.g., sun and water), all of which limits their effectiveness. Severely damaged or deteriorated bags can spill rock, which actually adds to the problem of construction debris rather than reducing it. And at the end of the construction project, removal and disposal of the rocks and rock bags can require considerable time and expense.

Furthermore, the rock bags at best only filter dirt, sand and large objects such as rocks and gravel. Other contaminants such as oil or smaller particles are not filtered by the rock bags, leaving those contaminants to pollute water supplies and clog drainage systems. Specifically, it would be advantageous to provide a filter that effectively filters particulate matter down to 10 microns, a size small enough to include hydrocarbon excess such as may build up on roads from gas and oil spillage, tire wear, and other motor vehicle usage. Such a filter would prevent such particulate waste from getting into the water system.

Many storm drains consist of horizontal openings covered by a grate. Filtering of large debris may be accomplished by the grate, which may have openings about 1″-2″ across. It is usually desirable to provide additional filtering. However, such horizontal drains are often disposed in the surface of pavement where they may be driven over by vehicles. As a result, it is undesirable to use means such as rock bags and the like above the grate to filter storm water entering the drain, because such objects on the pavement may be damaged by vehicles running over them and may also impose a traffic hazard.

Due to these restrictions, filtering of such horizontal drains is usually accomplished by placing filters in the vault below the grate. One such filter is disclosed in U.S. Pat. No. 5,788,849, which discloses a storm drain filter system for use under a horizontal grating. This patent discloses that in the vault beneath the grating a rack may hold a plurality of filters in a horizontal orientation. Each of these filters may hold filter components such as absorbent materials and/or geotextile fabric. One problem with this filter system is that debris that makes it past the grating may clog the horizontal filters beneath the grating. Once these horizontal filters are clogged, flooding may occur. As a result, to avoid flooding or to alleviate flooding after it occurs, such filters may need to be cleaned out.

As can be seen, there is a need for an improved apparatus and method that effectively filters storm water beneath a drain having a horizontal grating, which is not easily clogged by debris that passes through the grating. There is also a need for such a filter that reduces the likelihood of the occurrence of flooding if filter elements become clogged with debris.

### SUMMARY OF THE INVENTION

To overcome the limitations in the prior art briefly described above, the present invention provides an apparatus and method for filtering storm water entering a storm drain having horizontal grating.

In one aspect of the present invention, a fluid filter comprises: a primary filter configured to filter water passing therethrough, the primary filter having first and second ends; a mount for holding the planar filter in a chamber adjacent to an opening in the chamber, such that fluid passing through the opening substantially passes through the primary filter, the mount also holding the primary filter at an angle with respect to the opening such that the first end is closer to the planar surface than the second end and such that the second end, but not the first end, is in contact with a wall of the chamber.

In another aspect of the present invention, a filter assembly for filtering a fluid flowing into a storm drain comprises: a first filter panel tilted at an angle with respect to a storm drain opening such that a first end of the first filter panel is closer to the opening than a second end of the first filter panel; and a second filter panel tilted at an angle with respect to the storm drain opening, such that a first end of the second filter panel is farther away from the opening than a second end of the second filter panel and such that the first end of the first filter panel is adjacent to the first end of the second filter panel.

In a further aspect of the present invention, a storm drain comprises: a horizontal grate covering an opening above a storm drain vault; a first bristle filter panel disposed in the storm drain vault beneath the grate and tilted at an angle with respect to the grate such that a first end of the first bristle filter panel is closer to the grate than a second end of the first bristle filter panel; a second bristle filter panel disposed in the storm drain vault beneath the first bristle filter panel and tilted at an angle with respect to the grate such that a first end of the second bristle filter panel is farther away from the grate than a second end of the second bristle filter panel and such that the first end of the first bristle filter panel is adjacent to the first end of the second bristle filter panel; and wherein the first and second bristle filter panels each include bristle filters and a frame that holds the bristle filter, the bristle filter including a plurality of bristles attached at their proximate ends in an adjacent configuration along the length of a base.

These and other features, aspects and advantages of the present invention will become better understood with reference to the following drawings, description and claims.

### BRIEF DESCRIPTION OF THE DRAWINGS

FIG. 1 is a side cut-away view of a horizontal storm drain having a filter assembly according to an embodiment of the present invention;

FIG. 2 is perspective view of one of the filters in the filter assembly shown in FIG. 1;

FIG. 3 is a mounting assembly for a storm drain filter according to an embodiment of the invention;

FIG. 4 is a perspective view of the mounting assembly for a filter assembly having two filters according to an embodiment of the invention

FIG. 5 is a perspective view of mounting bracket for a filter assembly according to an embodiment of the invention;

FIG. 6 is a perspective view of the mounting bracket for a filter assembly shown in FIG. 5 according to an embodiment of the invention; and

FIG. 7 is a perspective view of mounting bracket for a filter assembly according to an embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a filtering system is disclosed herein that utilizes a filter assembly that includes a bristle filter for filtering out dirt, sand, rock, debris, and possibly other contaminants (such as oil) in drainage water run-off, and preventing it from entering into a water drainage system.

The filtering system is described herein in the context of a horizontal drain in pavement having a grating. It could be used in convention street drains or in a variety of other locations, for other drainage systems, and in a variety of implementations, such as municipalities or other governing bodies, that may be required to filter drainage water. In one implementation described herein, one or more bristle filters are affixed to frames that are designed to hold the filter assembly beneath a storm drain grating. The bristle filters are mounted in a configuration to filter drainage water against debris and other contaminants. The bristle filter is configured so that it will permit water to flow past it even when clogged with debris. Hence, the water may cascade from one filter to the next. This is unlike other storm drain filters, which could cause flooding because they would block water from flowing through the drain when clogged with debris.

As used herein the term “storm drain” includes any inlet positioned to receive drainage water, which is then directed using a drainage system that typically includes a network of pipes and conduits to a disposal area. Via this drainage system, typically the run-off water eventually flows into another body of water, such as a river, lake, or ocean. In land-locked locations, the run-off water may be directed to a low-lying area from which it can drain into the ground water, or evaporate.

Storm drains may have a number of forms; such as a curbside storm drain that has an inlet positioned to receive water as it flows along a curb, or a “stand-alone” storm drain (wash-out) that has an inlet anywhere on a surface where water would normally collect, such as a low point in a road or intersection. Usually storm drains are discussed in the context of a paved surface; however, storm drains may also be implemented on non-paved surfaces, such as rock, gravel, or dirt.

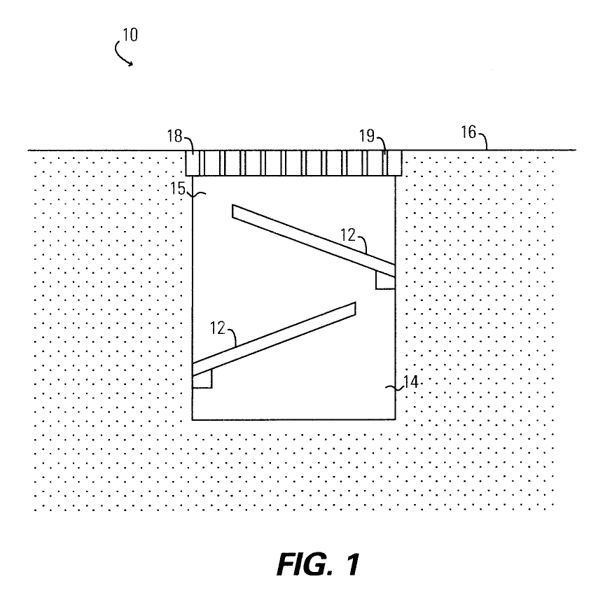

FIG. 1 is a cut-away side view of a portion of a storm drain 10 having two bristle filter panels 12 mounted within the drain vault 14. The storm drain vault 14 is disposed beneath an opening 15 in a paved surface 16, such as a road. The opening 15 is covered by a grating 18, which may comprise a conventional metal grating having openings 19 therein. The openings 19, which may be between 1″-2″ across, filter out large pieces of debris while allowing an adequate volume of water to flow into the storm drain 10.

The bristle filter panels 12 are mounted at an angle and do not extend across the entire width of the vault 14. In normal flow volume, such as during a light to medium rain, it can be expected that substantially all of the rainwater entering the storm drain 10 will be filtered by one or more of the bristle filter panels 12. In conditions where the flow of storm water is high, or when the bristle filter panels 12 have become clogged with debris, there is a path for water to flow around the left side of the upper bristle filter panel 12, around the right side of the lower bristle filter panel 12 and then into the vault 14.

It is generally not desirable for water to pass through the storm drain unfiltered, without having passed through either one of the bristle filter panels. However, it is even more desirable for the storm drain 10 not to become completely clogged, which can result in flooding. The storm drain 10 of present invention therefore provides a way to effectively prevent flooding while still filtering most of the storm water. Note that the percentage of unfiltered water is relatively low, because only some of the water will bypass the two bristle filter panels in the unusual circumstances of a very heavy rain, or if the two bristle filter panels are very clogged.

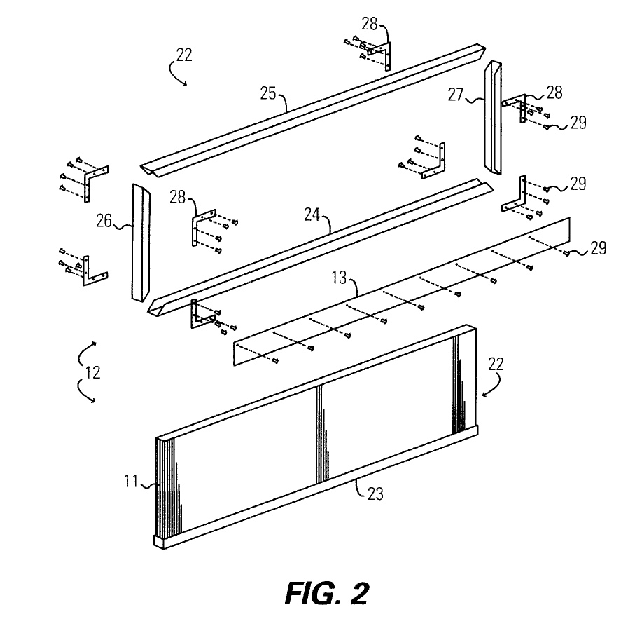

FIG. 2 is an exploded view of one filter assembly 29 that comprises filter components including a bristle filter panel 12. The filter panel includes a bristle filter and a plurality of structural components interconnected by suitable connectors. Advantageously, the rail and the bristle can be designed and implemented to save cost, and even to use off-the-shelf components.

The bristle filter panel 12 includes bristle filter 21 and structural panel components shown generally at 22. Generally, the bristle filter 21 includes the plurality of bristles 11 and a beam 23 to which the bristles are affixed at their lower ends in this embodiment. Specifically, the bristle filter panel includes a plurality of stiff but flexible bristles 11 bundled together at their lower ends, and held by the beam 23. The beam 23 holds the upper ends of the bristles together, and it may be rigid, or it may have some flexibility as appropriate for the desired use.

The bristles 11, held in place at their ends by the beam 23, are arranged in a configuration as appropriate for the intended use; typically, the ends of the bristles are affixed closely adjacent to each other. The affixed ends of the bristles are connected to the beam by any suitable means, such as glue and/or pressure provided by the beam (e.g., crimping by the beam), or molding. If the affixed ends of the bristles are positioned adjacent to each other, then the bristle density is determined by how closely the bristles can be practically positioned together. The bristles are oriented approximately perpendicular to the beam; however, in alternative embodiments the bristles may have a non-perpendicular orientation in any direction. The bristles 11 have a length, diameter, stiffness, and material chosen to provide the desired filtering action and a sufficient structural strength to withstand the force of flowing drainage water. For example, in one embodiment the bristles have a length of about 12.0 inches, a diameter of about 0.1 inch, and are comprised of polypropylene.

Generally, the bristles have a particular length, diameter, and arrangement as determined by the particular design and intended application. For example, the bristle's length and diameter are determined by design considerations such as the flexibility and strength of the bristles, and the particular material used. The arrangement of the bristles (e.g., the density and number of bristles) presented to the flowing water is also determined by design considerations; particularly the bristles are arranged with an appropriate depth from the front edge sufficient to withstand the force of flowing water; for example, if the bristles are formed of a relatively stiff material (e.g., polypropylene), and have a diameter of about 0.1″, a depth of four or five bristles from the front edge to the back edge may be sufficient.

One particularly advantageous material for the bristles 11 is polypropylene, which has been observed to “collect” oils, hydrocarbons, and organic compounds from the surface of water, which then adhere to the surface of the polypropylene bristles. This property further enhances the filtering ability of the bristles 11. Since the bristles “collect” such compounds by adherence, and the filter can be removed and cleaned to remove the collected compounds that adhere to the bristles, such a function can be particularly useful to reduce the amount of hydrocarbons and other organic compounds in drainage water run-off.

The panel components shown generally at 22 include a plurality of rails 24, 25, 26, and 27, a plurality of L-brackets 28 that connect the rails at the corners, and a plurality of connectors 29, such as screws or rivets that connect the L-brackets to the rails. The rails have a configuration to accept and receive the bristle filter 21; particularly a lower rail 24 has an interior section to engage the connecting beam 23, an upper rail 25 has an interior section to engage the loose ends of the bristles 11, and two side rails 26 and 27 have interior sections to engage the side bristles of the bristle filter 21.

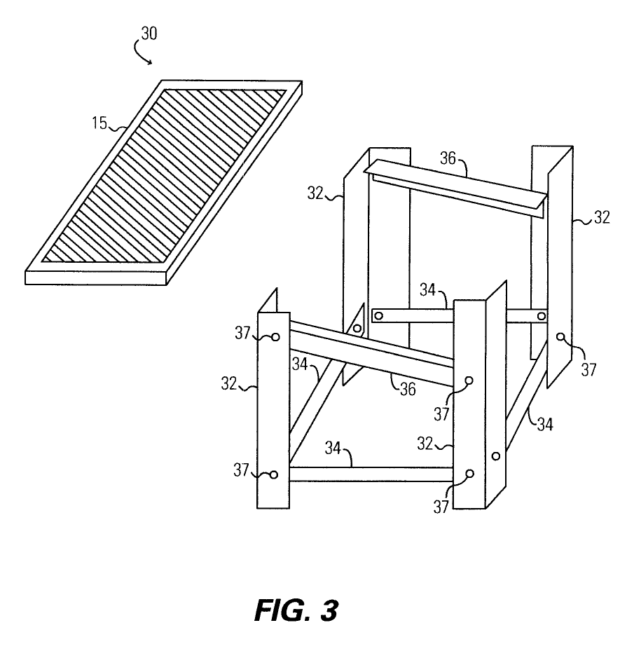

FIG. 3 shows a mounting assembly 30 for a storm drain filter according to an embodiment of the invention. Mounting assembly 30 is configured to hold a single bristle filter panel 12 inside a storm drain vault. The mounting assembly 30 includes four vertical L-brackets 32 connected by four flat brackets 34 near their lower ends. A filter mount 36 comprises two L-brackets mounted to the vertical L-brackets 32. The vertical L-brackets and the filter mounts 36 may be attached to each other by conventional fasteners 37, such as screws. The filter mount 36 is disposed at an angle so that the bristle filter panel 12 will be at an angle when placed on top of it, as shown in FIG. 1.

Mounting assembly 30 may be easily installed, simply by lowering into a storm drain vault where it may rest on the floor of the vault. Likewise, the bristle filter panels 12 may be easily removed and reinstalled for cleaning by simply lifting them off of the filter mounts 36.

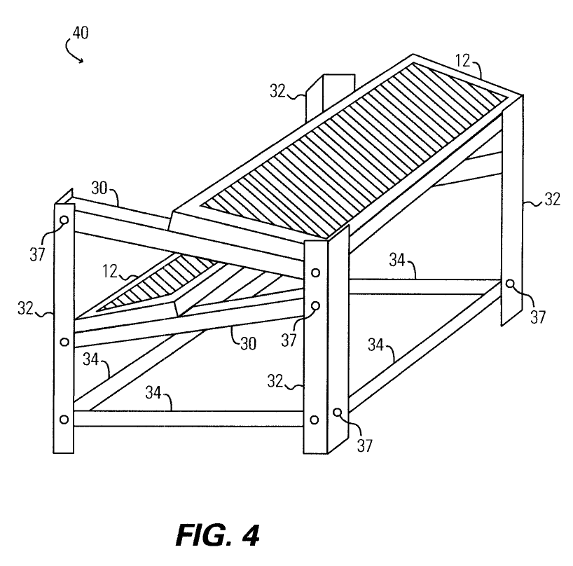

It will be appreciated that, while mounting assembly 30 as shown in FIG. 3 only includes a single filter mount 30, additional filter mounts may be added, depending on the number of desired bristle filter panels 12. It should be noted however, that when additional filter mounts 36 are used, they are preferably disposed so that adjacent bristle filter panels 12 are tilted in opposite directions, as shown in FIG. 1. FIG. 4 shows such a mounting assembly 40, which is similar to the mounting assembly 30 shown in FIG. 3, except that a second filter mount 30 is used to hold a second bristle filter panel 12.

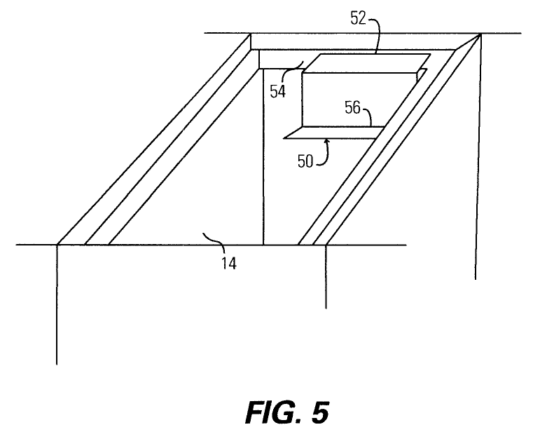

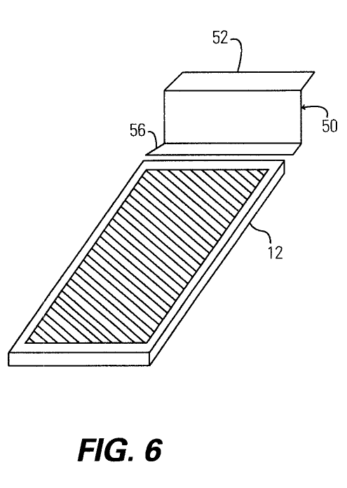

FIG. 5 shows an alternative filter mount disposed inside a storm drain vault 14. A pair of filter mounts 50 are configured with an upper horizontal surface disposed to rest on a storm drain ledge 54. Only one of the filter mounts 50 are visible in FIG. 5. A lower horizontal surface 56 is disposed at an angle to hold one end of a bristle filter panel 12 (not shown) at the desired angle as shown in FIG. 5. Filter mounts 50 may be attached to the vault or may simply be held in place by gravity and by the grate 18 (not shown). FIG. 6 shows additional details of the filter mount 50 with the bristle filter panel 12 adjacent to it.

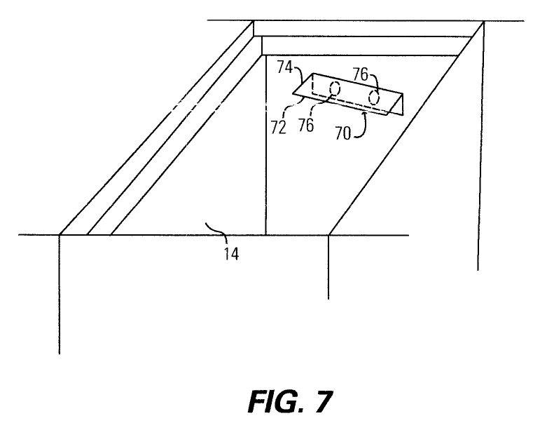

The different ways to mount bristle filter panels 12 shown in FIGS. 3-6 have the advantage of not requiring a means to fasten them to the vault 14. Alternatively, FIG. 7 shows an embodiment where a filter mount 70 is permanently attached to the storm drain vault 14. In particular, filter mount 70 comprises a pair of L-brackets 72 having a flat surface 74 on which each end of a bristle filter panel 12 may rest. The L-brackets 72 may be attached to the wall of the vault 14 by means of conventional concrete fasteners 76. When a bristle filter panel 12 is placed on the flat surface 74, it will be held in place within the vault 14, as shown in FIG. 1. The bristle filter panel 12 may then be easily removed by lifting it out of the vault when they need cleaning or replacing.

It should be noted that, while the bristle filter panels 12 may become clogged with debris, and require cleaning, they will not cause flooding when clogging. Thus, they may be cleaned on a regular schedule and should not require cleaning during the emergency of a flooding situation. Also, it may be noted that due to gravity, particles and sediment will collects at the bristle filter panel 12 near the wall of the vault where there is lower fluid velocity, which encourages settling of particles suspended in the fluid. Furthermore, in other embodiments the bristle filter panel may be replaced by an alternative filter that does not include filters, or which includes bristles in combination with other filter materials. In addition, the angle of the filters may depend on the nature of the application. While a relatively small angle of 2-10 degrees may be effective, there may be applications where a larger angle, such as 10-45 degrees may be desirable.

While not shown in FIGS. 1-7, there may be any number of additional bristle filter panels 12 disposed below the first and second bristle panels shown in FIG. 1. Also, there may be additional conventional filters present in the vault 14 below the bristle filter panels 12. For example, filters such as those shown in U.S. Pat. No. 5,788,849 may be used beneath the bristle filter panels 12. The operation of these conventional filters downstream may be improved by the presence of the bristle filter panels 12, because they will be less prone to clogging by debris and will be more effective in filtering finer particles and substances.

As can be appreciated by those skilled in the art, the present invention provides an improved apparatus and method of filtering water in a storm drain. The invention provides effective filtering with a reduced risk of flooding because of a bypass mechanism that permits water to flow past the filters even if the filters are clogged.

It should be understood, of course, that the foregoing relates to exemplary embodiments of the invention and that modifications may be made without departing from the spirit and scope of the invention as set forth in the following claims.

We claim:

1. A fluid filter comprising:
a primary filter configured to filter water passing therethrough, said primary filter having first and second ends;
a mount for holding said planar filter in a chamber adjacent to an opening in said chamber, such that fluid passing through said opening substantially passes through said primary filter, said mount also holding said primary filter at an angle with respect to said opening such that said first end is closer to said planar surface than said second end and such that said second end, but not said first end, is in contact with a wall of said chamber.

2. The fluid filter of claim 1 further comprising:
a downstream filter configured to filter water passing therethrough, said downstream filter having first and second ends; and
a second mount holding said downstream filter in said chamber such that fluid passing through said planar filter substantially passes through said downstream filter, said second mount also holding said downstream filter at an angle such that said first end of said downstream filter is adjacent to said first end of said planar filter and said first end, but not said second end, is in contact with a wall of said chamber.

3. The fluid filter of claim 2 wherein said first and second mounts hold said primary and downstream filters such that fluid may pass around said first end of said primary filter and then around said second end of said downstream filter.

4. The fluid filter of claim 1 wherein said primary filter includes a plurality of bristles which filter water passing through said primary filter.

5. The fluid filter of claim 4 wherein said downstream filter includes a plurality of bristles which filter water passing through said downstream filter.

6. The fluid filter of claim 1 wherein said fluid is water.

7. The fluid filter of claim 1 further comprising a grate disposed across said opening, said grate having openings threrethrough to block debris from entering said chamber.

8. The fluid filter of claim 7 wherein said grate is disposed in a horizontal orientation.

9. The fluid filter of claim 1 wherein said opening is disposed in a surface of pavement.

10. The fluid filter of claim 1 wherein said chamber is a storm drain vault.

11. The fluid filter of claim 4 wherein said primary filter and said downstream filter each include bristle filters and a frame that holds said bristle filters, said bristle filters including a plurality of bristles attached at their proximate ends in an adjacent configuration along the length of a base.

12. A filter assembly for filtering a fluid flowing into a storm drain comprising:
a first filter panel tilted at an angle with respect to a storm drain opening such that a first end of said first filter panel is closer to said opening than a second end of said first filter panel; and
a second filter panel tilted at an angle with respect to said storm drain opening, such that a first end of said second filter panel is farther away from said opening than a second end of said second filter panel and such that said first end of said first filter panel is adjacent to said first end of said second filter panel.

13. The filter assembly of claim 12 wherein said first and second filter panels each include bristle filters and a frame that holds said bristle filters, said bristle filters including a plurality of bristles attached at their proximate ends in an adjacent configuration along the length of a base;

14. The filter assembly of claim 12 further comprising a grate disposed across said storm drain opening.

15. The filter assembly of claim 12 wherein said first and second filter panels are disposed such that fluid may pass around said first end of said first filter panel and then around said second end of said second filter panel.

16. The filter assembly of claim 1 wherein said opening is disposed in a surface of pavement.

17. The filter assembly of claim 13 wherein said bristles are composed of polypropylene.

18. A storm drain comprising:
a horizontal grate covering an opening above a storm drain vault;
a first bristle filter panel disposed in said storm drain vault beneath said grate and tilted at an angle with respect to said grate such that a first end of said first bristle filter panel is closer to said grate than a second end of said first bristle filter panel;
a second bristle filter panel disposed in said storm drain vault beneath said first bristle filter panel and tilted at an angle with respect to said grate such that a first end of said second bristle filter panel is farther away from said grate than a second end of said second bristle filter panel and such that said first end of said first bristle filter panel is adjacent to said first end of said second bristle filter panel; and
wherein said first and second bristle filter panels each include bristle filters and a frame that holds said bristle filter, said bristle filter including a plurality of bristles attached at their proximate ends in an adjacent configuration along the length of a base.

19. The storm drain of claim 18 further comprising a third bristle filter panel disposed in said storm drain vault beneath said second bristle filter panel and tilted at an angle with respect to said grate such that a first end of said third bristle filter panel is closer to said grate than a second end of said third bristle filter panel and such that said first end of said third bristle filter panel is adjacent to said first end of said second bristle filter panel.

20. The storm drain of claim 18 wherein said first and second bristle panels comprise polypropylene bristles.
